(19) United States
(12) Patent Application Publication
(10) Pub. No.: US 2023/0360491 A1
(43) Pub. Date: Nov. 9, 2023

(54) SYSTEMS AND METHODS FOR FANTASY GAME

(71) Applicant: Covin Conrady, Edmond, OK (US)

(72) Inventor: Covin Conrady, Edmond, OK (US)

(21) Appl. No.: 18/184,948

(22) Filed: Mar. 16, 2023

Related U.S. Application Data
(60) Provisional application No. 63/364,128, filed on May 4, 2022.

(51) Int. Cl. G07F 17/32

(52) U.S. Cl. CPC G07F 17/3288; G07F 17/323

(57) ABSTRACT

Systems and methods for a fantasy game including a predetermined set of potential outcomes being received. Each potential outcome has an outcome type, an outcome selection, and an outcome value. A first signal is received from one or more users. The first signal is indicative of a selected set of potential outcomes. Each potential outcome in the selected set further has a selection position. For one or more potential outcome of the selected set of potential outcomes, an actual outcome value is determined for the outcome type and the outcome selection. A selected set value is determined for the selected set of potential outcomes based at least in part on the relationship between the outcome value and the actual outcome value and at least in part based on the relationship between the outcome value, the actual outcome value, and the selection position.

### CROSS-REFERENCE TO RELATED APPLICATIONS

This application claims the benefit of U.S. Provisional Application No. 63/364,128, filed May 4, 2022, which is hereby incorporated herein by reference in its entirety.

### BACKGROUND

A fantasy sports game is a competition amongst peers wherein the players assemble a lineup of real-world athletes or bets relating to real-world sporting events. The real-world performance of those athletes or the real-world outcomes of those bets determines the winner. Leagues associated with fantasy sports games form in many facets of an individual's life, including family and work environments.

In traditional fantasy sports games, players within individual leagues gather before the opening of the sports season and draft or auction teams of real-world athletes to form a fantasy roster. After the draft, players will create lineups from their respective rosters on a predetermined time frame (e.g., every week in an NFL fantasy sports league). A score will be calculated based on the athletes' real-world performances, such as points scored by the athlete in a competition. Generally, the player whose lineup scores the most points during the time frame wins. However, some players view traditional fantasy sports games as boring and/or that the fantasy league winner is likely determined as soon as the draft is complete. This causes many to lose interest as the season progresses.

More modern fantasy sports games may be formatted so that players form their lineups as a selection of bets. Generally, the bets are provided by the game, determined by a professional odds-maker, or even determined by the players. For example, a professional odds-maker may believe that Pro Football Team A will beat Pro Football Team B by ten points in the upcoming weekend. Thus, the “line” would be “Pro Football Team A (−10).” A fantasy sports player could select a bet of Pro Football Team A to win by more than ten points as one selection in their lineup. If Pro Football Team A wins by more than ten points, the player will receive a number of points. If Pro Football Team A wins by ten or fewer points or loses, the player may be awarded less or no points or even deducted points.

Odds and bets on real-world events are well-known and understood by those skilled in the art of fantasy sports games and/or sports wagering. For example, CBS Sports and Yahoo Sports provide fantasy sports games wherein users may select several bets provided by the game. The winner is determined by the number of points awarded for choosing the bets later determined to be correct. These games are well understood by those with knowledge and skill in the art and are hereby incorporated by reference.

Many fantasy players prefer this modern style as it avoids the issues presented by traditional fantasy sports games and allows players to stay engaged in more than one sport at a time. For example, a player may select two bets on professional basketball games and three others on professional football games. It is thought to take more “skill” to win because the players must choose the winning side of a given line or bet. However, even in this league style, players may become less engaged throughout the season if their point totals are too low to catch other players. Players also lose interest as soon as the outcome of the bet has been decided in any given event because there is no award or deduction of points based on the difference between the predicted outcome and the actual outcome. Additionally, this style of play results in a substantial number of the players ending with identical scores, causing ties. Thus, the prior art cannot provide each of a substantial number of players with a distinct rank.

To this end, a need exists for a computer operating a fantasy game that improves the operation of the computer to overcome the problems of the prior art. The inventive concepts disclosed herein are directed to such a computer operating fantasy game.

### SUMMARY OF THE INVENTIVE CONCEPTS

In accordance with an aspect of the inventive concepts, a computer system for a fantasy game is disclosed. In some embodiments, the fantasy game can be a fantasy sports game. The system includes a processor and a non-transitory computer readable memory storing computer executable instructions that when executed by the processor causes the processor to: receive a predetermined set of potential outcomes, each potential outcome having an outcome type, an outcome selection, and an outcome value; receive a first signal from one or more user device, the first signal indicative of a selected set of potential outcomes, each potential outcome in the selected set further having a selection position; for one or more potential outcome of the selected set of potential outcomes, determine an actual outcome value for the outcome type and the outcome selection; determine a selected set value for the selected set of potential outcomes based at least in part on the relationship between the outcome value and the actual outcome value and at least in part based on the relationship between the outcome value, the actual outcome value, and the selection position; and transmit, to the one or more user device, a second signal indicative of the selected set value and a selected set status.

In accordance with an aspect of the inventive concepts, a method for providing a fantasy game is disclosed. The method includes receiving a predetermined set of potential outcomes, each potential outcome having an outcome type, an outcome selection, and an outcome value; receiving a first signal from one or more user device, the first signal indicative of a selected set of potential outcomes, each potential outcome in the selected set further having a selection position; for one or more potential outcome of the selected set of potential outcomes, determining an actual outcome value for the outcome type and the outcome selection; and determining a selected set value for the selected set of potential outcomes based at least in part on the relationship between the outcome value and the actual outcome value and at least in part based on the relationship between the outcome value, the actual outcome value, and the selection position.

### BRIEF DESCRIPTION OF THE DRAWINGS

FIG. 1 is a diagram of an exemplary embodiment of a computer system for carrying out a fantasy game system constructed in accordance with the inventive concepts disclosed herein.

FIG. 2 is a flow diagram of an exemplary embodiment of a fantasy game performed in accordance with the inventive concepts disclosed herein.

FIG. 3 is a flow diagram of another exemplary embodiment of a fantasy game performed in accordance with the inventive concepts disclosed herein.

### DETAILED DESCRIPTION OF EXEMPLARY EMBODIMENTS

Before explaining at least one embodiment of the inventive concepts disclosed, it is to be understood that the inventive concepts are not limited in their application to the details of construction and the arrangement of the components or steps or methodologies in this description or illustrated in the drawings. The inventive concepts disclosed are capable of other embodiments or of being practiced or carried out in various ways. Also, it is to be understood that the phraseology and terminology employed is for description only and should not be regarded as limiting the inventive concepts disclosed and claimed herein.

In this detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features may not be described to avoid unnecessarily complicating the disclosure.

Further, unless stated to the contrary, “or” refers to an inclusive “or” and not to an exclusive “or.” For example, a condition A or B is satisfied by anyone of: A is true (or present) and B is false (or not present), A is false (or not present) and B is true (or present), and both A and B are true (or present).

As used in the description herein, the terms “comprises,” “comprising,” “includes,” “including,” “has,” “having,” or any other variations thereof are intended to cover a nonexclusive inclusion. For example, unless otherwise noted, a process, method, article, or apparatus that comprises a list of elements is not necessarily limited to only those elements but may also include other elements not expressly listed or inherent to such process, method, article, or apparatus.

In addition, use of the “a” or “an” are employed to describe elements and components of the embodiments herein. This is done merely for convenience and to give a general sense of the inventive concepts disclosed. This description should be read to include one or at least one, and the singular also includes the plural unless it is obvious that it is meant otherwise.

As used herein, qualifiers like “substantially,” “about,” “approximately,” and combinations and variations thereof are intended to include not only the exact amount or value that they qualify but also some slight deviations therefrom, which may be due to computing tolerances, computing error, manufacturing tolerances, measurement error, wear and tear, stresses exerted on various parts, and combinations thereof, for example.

As used herein, any reference to “one embodiment” or “an embodiment” means that a particular element, feature, structure, or characteristic described in the embodiment is included in at least one embodiment. The appearances of the phrase “in one embodiment” in various places in the specification are not necessarily all referring to the same embodiment.

The use of ordinal number terminology (i.e., “first,” “second,” “third,” “fourth,” etc.) is solely to differentiate between two or more items and, unless explicitly stated otherwise, is not meant to imply any sequence or order or importance to one item over another or any order of addition.

The term “at least one” or “one or more” will be understood to include one and any quantity of more than one. In addition, the phrase “at least one of X, V, and Z” will be understood to include X alone, V alone, and Z alone, as well as any combination of X, V, and Z.

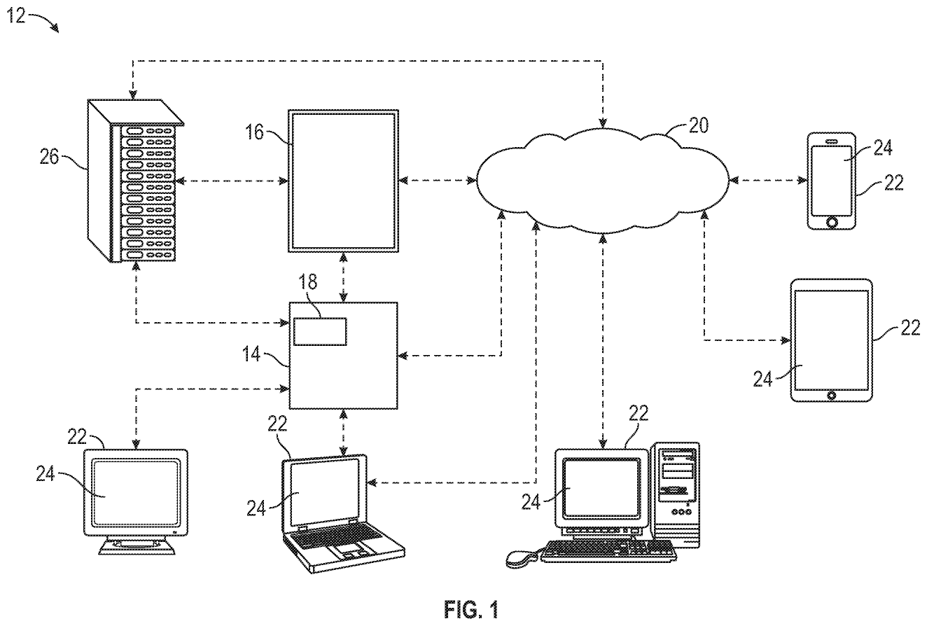

Referring to the drawings, and more particularly to FIG. 1, a fantasy game 10, in one embodiment, may be played on one or more computer systems 12. The fantasy game 10 will be described herein as a fantasy sports game. It should be understood, however, that the fantasy game 10 can relate to various real-world events. For example, the fantasy game 10 may include a predetermined set of potential outcomes relating to politics or entertainment.

Shown therein is a diagram of an exemplary embodiment of one or more computer systems 12. The computer system 12 may comprise one or more computer processor 14, and one or more non-transitory memory 16. The computer processor 14 may include (or be communicatively coupled with) one or more communication components 18. The computer processor 14 or multiple computer processors 14 may or may not necessarily be located in a single physical location.

The computer system 12 may include a network 20 enabling bidirectional communication between the computer processor 14 and the non-transitory memory 16 with one or more user devices 22. The one or more user devices 22 may communicate via the network 20 and/or display information on a display 24.

The user devices 22 may enable one or more users, e.g., a player, an administrator, a league manager, or other system users, access to the fantasy game 10. It will be understood that the one or more user devices 22 may be any user device with network access capabilities, including a computer, tablet, or cell phone. The present disclosure is not limited by the type of user device used to access the fantasy game 10. It will be further understood that the inventive concepts disclosed herein are not limited to a visual display on the one or more user devices 22, but may include any form of sensory communication element, such as a microphone or haptic feedback device.

In one embodiment, the network 20 is the internet and the user devices 22 interface with the computer processor 14 via the communication component 18 using a series of web pages. It should be noted, however, that the network 20 may be almost any type of network and may be implemented as the World Wide Web (or Internet), a local area network (LAN), a wide area network (WAN), a metropolitan network, a wireless network, a cellular network, a Global System for Mobile Communications (GSM) network, a code division multiple access (CDMA) network, a 3G network, a 4G network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

In one embodiment, the computer processor 14 and the non-transitory memory 16 may be implemented with a server system 26 having multiple servers in a configuration suitable to provide a commercial computer-based business system such as a commercial website and/or data center. Additionally, it is understood that multiple different server systems 26 may be used.

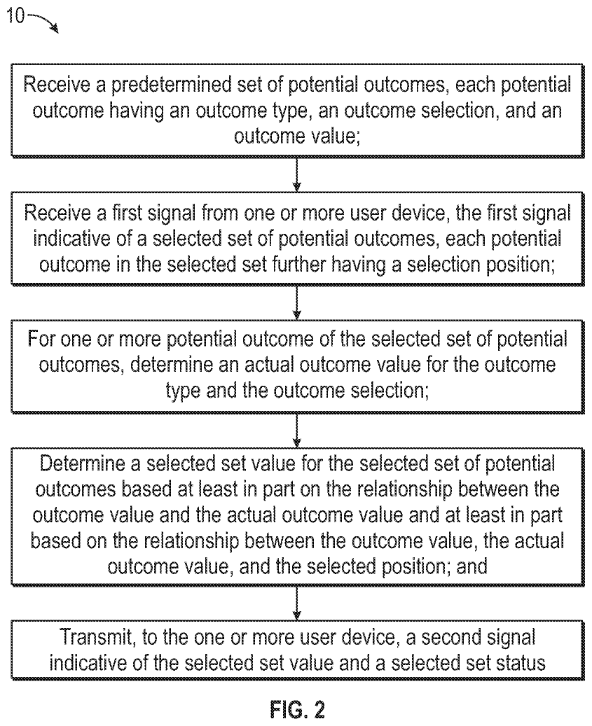

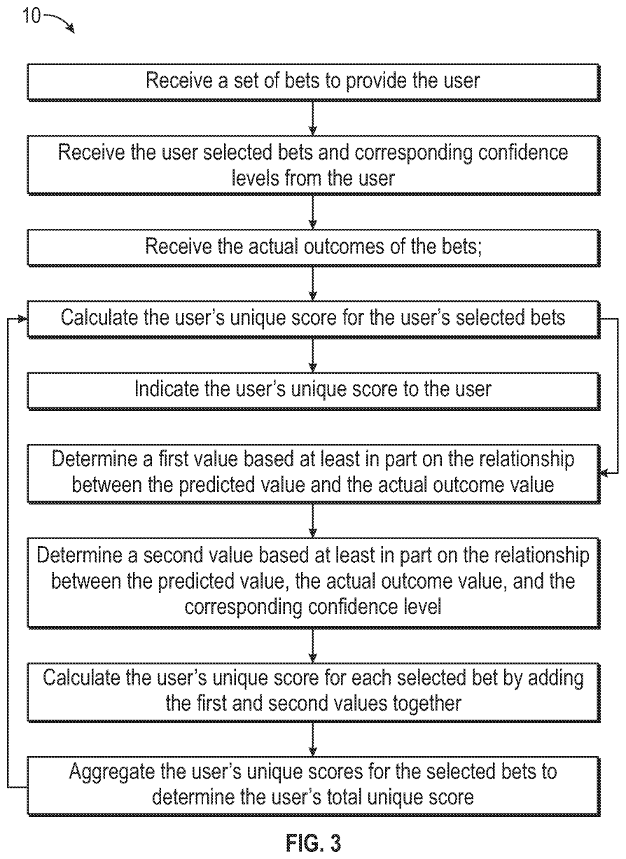

Referring now to FIG. 2, a method of conducting the fantasy game 10 is disclosed. The method may be performed by computer system 12. The fantasy game 10 includes the computer system 12 receiving a predetermined set of potential outcomes. As shown in FIGS. 2 and 3, the predetermined set of potential outcomes may be odds or bets relating to real-world events, including sporting events. However, it will be understood that the kind of real-world event does not limit the present invention and that betting relates to various real-world events. For example, the fantasy game 10 may include a predetermined set of potential outcomes relating to politics or entertainment.

The predetermined set of potential outcomes may be received from an outcome generator or external source, such as an application programming interface (“API”). APIs are well-known and understood by those of ordinary skill in the art. Various APIs exist that supply bets or odds relating to real-world events. It is further understood that the predetermined set of potential outcomes may be received from more than one API.

Moreover, it will be understood that various types of bets and odds exist, e.g., money line, point spread, over/under, parlay, proposition (“prop”), teaser, futures, etc. The present disclosure is not limited by the type of predetermined set of potential outcomes received. In one embodiment, the fantasy game 10 includes the computer system 12 receiving any and all kinds of bets.

In one embodiment, the administrator, league manager, or other at least one user supplies the predetermined set of potential outcomes to computer system 12 of the fantasy game 10. League managers are understood in the art of fantasy games. Primarily, the league manager is responsible for the general administration of an individual league, including deciding what options to add or remove, adjusting points, adding or removing lineup selections, setting the schedule, draft time and type, etc. The fantasy game 10 may be set up in such a way that the administrator, league manager, and/or user(s) supply only a preferred predetermined set of potential outcomes. The predetermined set of potential outcomes may also be received from an odds-maker, such as a professional odds-maker.

In one embodiment, the predetermined set of potential outcomes may include an outcome type, an outcome selection, and an outcome value. In one embodiment, the outcome type may indicate the type of bet (e.g., money line, over/under, etc.). The outcome selection may indicate further information relating to the bet, such as to which specific team, player, or game the bet is directed. The outcome value may indicate a value determinative of the bet, such as a numerical value. For example, the predetermined potential outcome may be a bet on a professional basketball player to score more than twenty points in a particular game wherein the outcome type may be over/under, the outcome selection may be the player's name, and the outcome value may be twenty points.

In one embodiment, a first signal is received by the computer system 12 from the one or more user device 22. The first signal may include a selected set of potential outcomes. The selected set of potential outcomes may be a set selected from the predetermined set of potential outcomes. The selected set of potential outcomes may be a selection of bets or odds relating to real-world events, including sporting events. For example, one selection of the selected set of potential outcomes may be an individual player scoring bet as described above.

As was described concerning the receiving of potential outcomes, the selected set of potential outcomes may include various types of bets and is not limited to any number of potential outcomes. Of course, the administrator or league manager may limit the number or type of potential outcomes the user may select for any given round, season, etc.

Each potential outcome of the selected set of potential outcomes may include a selected position. In one embodiment, the selected positions of the potential outcomes are used to embrace or employ the concepts of “confidence levels” and “multipliers.” The concepts of confidence levels and multipliers are well understood by those with skill in the art of fantasy sports games and sports wagering. A confidence level or multiplier may be applied to a user's selected bet to increase the number of points awarded or deducted for that selected bet depending on the outcome of the selected bet.

In one embodiment, an actual outcome value of the one or more potential outcomes for the selected set of potential outcomes may be determined. The actual outcome value may be for the outcome type and the outcome selection of the potential outcome. For example, if the potential outcome were a bet, then the actual outcome of the bet would be determined. As a more specific example, if the potential outcome was a bet relating to the over/under of a real-world football game, then the actual outcome value would be indicative of the total points scored in that game or the difference between the predicted total number of points to be scored and the actual total number of points scored.

Various methods may determine the actual outcome value of the potential outcomes, and the present disclosure is not limited to a particular source or method for determining the actual outcome. The actual outcome values may be determined similarly to the predetermined set of potential outcomes, i.e., an outcome generator, API, administrator, league manager, and/or one or more users.

A selected set value will be determined by the computer system 12 for the selected set of potential outcomes. In one embodiment, the selected set value may be a unique score for the fantasy game 10.

The selected set value may be based at least in part on the relationship between the outcome value and the actual outcome value and at least in part based on the relationship between the outcome value, the actual outcome value, and the selection position. For example, the unique score may be calculated wherein the user is first awarded, not awarded, or deducted points based at least in part on the relationships between the outcome values of the selected set and the actual outcome values of the selected set, and the user is second awarded, not awarded, or deducted points based on relationships between the outcome values of the selected set, the actual outcome values of the selected set, and the selection positions of the selected set.

In one embodiment, the user is awarded, not awarded, or deducted a first value of points for each selected bet based on selecting the correct outcome of the bet. For example, if the user selects a bet on a basketball team to score more than ninety points in a game, and that team scores more than ninety points in that game, the user may be awarded points. Conversely, the user may not be awarded or may be deducted points if the team does not score more than ninety points. In one embodiment, the first value may be a predetermined numerical value, such as 100 points.

In one embodiment, the first value may be an odds value (the “payout value”) corresponding to the selected bet. Odds values are generally known to those in the art. Further, it is generally known to those in the art that odds values are determined using a standard $100 wager. For example, if the odds for a bet are −110 (under the American odds system), and a person puts a $100 wager on that bet, the odds value would be $90.91. Thus, for example, a user may select a bet wherein a basketball team has −110 odds of scoring more than ninety points in a game. The odds value corresponding to a $100 wager on this bet would be $90.91. If the user selects this bet and the basketball team scores more than ninety points in the game, the user may be awarded a first value of 90.91 points.

The user may be awarded, not awarded, or deducted a second value of points for each selected bet based on the difference between the predicted outcome and the actual outcome of the bet. For example, if the user selects a bet on a basketball team to score more than the predicted ninety points in a game, and that team scores ninety-nine points in that game, the user may be awarded a number of points, such as nine points. Conversely, the user may not be awarded or may be deducted points if the team does not score more than ninety points. If the team only scores eighty-five points, the user may be awarded no points or may be deducted a number of points, such as five points.

Moreover, the second value of points awarded, not awarded, or deducted may be multiplied by the corresponding selected position of each selected bet. For example, if the basketball team scores ninety-nine points, the user may be awarded a number of additional points for selecting that bet for a second selected position, such as eighteen points, or thirty-six additional points for selecting that bet for a fourth selected position.

The user's unique score may be calculated by adding the first and second values together.

An exemplary embodiment of the unique scoring system disclosed herein is illustrated below as Example 1.

| | Set of | | | | | |
|---|---|---|---|---|---|---|
| Confidence | Predicted | User Selected | Actual | | Second | Unique |
| Level | Outcomes | Bet | Outcome | First Value | Value | Score |
| 1 | Chiefs v. Bills | Chiefs (−2.5) | Chiefs win by | 100 | 1 × 3.5 = | 103.5 |
| | (Chiefs: −2.5) | | 6 | | 3.5 | |
| 2 | Chiefs v. Bills | Over 54 | Final Score | 100 | 2 × 24 = | 148 |
| | (O/u: 54) | | Total: 78 | | 48 | |
| 3 | Packers v. | Packers (−5.5) | 49ers win by 3 | 0 | 3 × −8.5 = | −25.5 |
| | 49ers | | | | −25.5 | |
| | (Packers: | | | | | |
| | −5.5) | | | | | |
| 4 | Kansas v. | Kansas (−10.5) | Kansas wins | 0 | 4 × −8.5 = | −34 |
| | Oklahoma | | by 2 | | −34 | |
| | (NCAAB) | | | | | |
| | (Kansas: | | | | | |
| | −10.5) | | | | | |
| 5 | Warriors v. | Stephen Curry, | Stephen Curry | 100 | 5 × 9.5 = | 147.5 |
| | Clippers | over 23.5 | Points: 33 | | 47.5 | |
| | (Stephen | | | | | |
| | Curry, Points | | | | | |
| | O/u: 23.5) | | | | | |

User's Unique Score: 339.5 Points

### Example 1

The user may select a plurality of bets from the predetermined set of predicted outcomes relating to at least one sporting event. In Example 1, the user has selected five bets from the predetermined set of potential outcomes:
(1) the Kansas City Chiefs to beat the Buffalo Bills by more than two and a half points;
(2) The total scored points of the Chiefs-Bills game to be greater than fifty-four points;
(3) The Packers to beat the 49ers by more than five and a half points;
(4) The University of Kansas men's basketball team to beat the University of Oklahoma men's college basketball team by more than ten and a half points; and
(5) Stephen Curry to score more than twenty-three and a half points in a game between the Golden State Warriors and the Los Angeles Clippers.

According to the unique scoring system disclosed herein, the user was awarded 339.5 fantasy points in this example for these selected potential outcomes based at least in part on the relationship between the outcome value and the actual outcome value and at least in part based on the relationship between the outcome value, the actual outcome value, and the selection position. In this example, the user was awarded 100 points each for correctly selecting the Chiefs to cover two and a half points, the total in the Chiefs-Bills game to be greater than fifty-four points, and Stephen Curry to score more than twenty-three points against the Clippers. The user was not awarded any points for incorrectly selecting the Packers to cover five and a half points and Kansas to cover ten and a half points. These first values reflect the relationships between the outcome values and the actual outcome values. Therefore, the user's score is at least in part based on these relationships. It is worth noting that the inventive concepts disclosed herein are not limited to this exact scoring system. For example, in one embodiment, users are deducted points for selecting a bet determined to be incorrect or provided some or no points for “pushing” a bet.

As further illustrated in Example 1, the user may be awarded, not awarded, or deducted a second value of points based on the relationship between the outcome value, the actual outcome value, and the selection position. In this example, the selected positions of the selected potential outcomes are confidence levels. The user was awarded three and a half points because the Chiefs covered by three and a half points, and the user selected this bet in a first confidence level (3.5×1=3.5). Thus, three and a half points were added to the user's fantasy score. The user was awarded forty-eight points because the total points scored in the Chiefs-Bills game was twenty-four points higher than the predicted outcome, fifty-four points, and the user placed this bet in the second confidence level (24×2=48). The user was deducted twenty-five and a half points because the difference in the predicted outcome and actual outcome was eight and a half points, and the user placed this bet in the third confidence level (−8.5×3=−25.5). The user was deducted thirty-four points because the difference between the predicted and actual outcomes was eight and a half points, and the user placed this bet in the fourth confidence level (−8.5×4=−34). The user was awarded forty-seven and a half points because Stephen Curry scored nine and a half points more than his projected number of points against the Clippers, and the user placed this bet in the fifth confidence level (9.5×5=47.5). Thus, the user is awarded thirty-nine and a half points based on the relationships between the outcome values, the actual outcome values, and the selection positions of the respective selected potential outcomes. The user's unique fantasy score is calculated by adding the first and second values together (300+39.5=339.5).

Another exemplary embodiment of the unique scoring system disclosed herein is illustrated below as Example 2.

| | Set of | User | | | | | |
|---|---|---|---|---|---|---|---|
| Confidence | Predicted | Selected | | Actual | First | Second | Unique |
| Level | Outcomes | Bet | Odds | Outcome | Value | Value | Score |
| 1 | Chiefs v. | Chiefs (−2.5) | (−110) | Chiefs win | 90.91 | 1 × 3.5 = | 94.41 |
| | Bills | | | by 6 | | 3.5 | |
| | (Chiefs: | | | | | | |
| | −2.5) | | | | | | |
| 2 | Chiefs v. | Over 54 | (−107) | Final Score | 93.46 | 2 × 24 = | 141.46 |
| | Bills (O/u: | | | Total: 78 | | 48 | |
| | 54 | | | | | | |
| 3 | Packers v. | Packers | (−105) | 49ers win | 0 | 3 × −8.5 = | −25.5 |
| | 49ers | (−5.5) | | by 3 | | −25.5 | |
| | (Packers: | | | | | | |
| | −5.5) | | | | | | |
| 4 | Kansas v. | Kansas | (−110) | Kansas | 0 | 4 × −8.5 = | −34 |
| | Oklahoma | (−10.5) | | wins by 2 | | −34 | |
| | (NCAAB) | | | | | | |
| | (Kansas: | | | | | | |
| | −10.5) | | | | | | |
| 5 | Warriors v. | Stephen | (+115) | Stephen | 115 | 5 × 9.5 = | 162.5 |
| | Clippers | Curry, | | Curry | | 47.5 | |
| | (Stephen | over | | Points: 33 | | | |
| | Curry, | 23.5 | | | | | |
| | Points O/u: | | | | | | |
| | 23.5) | | | | | | |

User's Unique Score: 338.87 Points

### Example 2

The user may select a plurality of bets from the predetermined set of predicted outcomes relating to at least one sporting event. In Example 2, the user has selected five bets from the predetermined set of potential outcomes:
(1) the Kansas City Chiefs to beat the Buffalo Bills by more than two and a half points;
(2) The total scored points of the Chiefs-Bills game to be greater than fifty-four points;
(3) The Packers to beat the 49ers by more than five and a half points;
(4) The University of Kansas men's basketball team to beat the University of Oklahoma men's college basketball team by more than ten and a half points; and
(5) Stephen Curry to score more than twenty-three and a half points in a game between the Golden State Warriors and the Los Angeles Clippers.

According to the unique scoring system disclosed herein, the user was awarded 338.87 fantasy points in this example for these selected potential outcomes based at least in part on the relationship between the outcome value and the actual outcome value and at least in part based on the relationship between the outcome value, the actual outcome value, and the selection position. In this example, the user was awarded the odds value, or “payout value,” in points corresponding to the standard $100 wager for each correctly selected bet: the Chiefs to cover two and a half points, the total in the Chiefs-Bills game to be greater than fifty-four points, and Stephen Curry to score more than twenty-three points against the Clippers. The user was not awarded any points for incorrectly selecting the Packers to cover five and a half points and Kansas to cover ten and a half points. These first values reflect the relationships between the outcome values and the actual outcome values. Therefore, the user's score is at least in part based on these relationships. It is worth noting that the inventive concepts disclosed herein are not limited to this exact scoring system. For example, in one embodiment, users are deducted points for selecting a bet determined to be incorrect or provided some or no points for “pushing” a bet.

As further illustrated in Example 2, the user may be awarded, not awarded, or deducted a second value of points based on the relationship between the outcome value, the actual outcome value, and the selection position. In this example, the selected positions of the selected potential outcomes are confidence levels. The user was awarded three and a half points because the Chiefs covered by three and a half points, and the user selected this bet in a first confidence level (3.5×1=3.5). Thus, three and a half points were added to the user's fantasy score. The user was awarded forty-eight points because the total points scored in the Chiefs-Bills game was twenty-four points higher than the predicted outcome, fifty-four points, and the user placed this bet in the second confidence level (24×2=48). The user has deducted twenty-five and a half points because the difference in the predicted outcome and actual outcome was eight and a half points, and the user placed this bet in the third confidence level (−8.5×3=−25.5). The user has deducted thirty-four points because the difference in the predicted outcome and actual outcome was eight and a half points, and the user placed this bet in the fourth confidence level (−8.5×4=−34). The user was awarded forty-seven and a half points because Stephen Curry scored nine and a half points more than his projected number of points against the Clippers, and the user placed this bet in the fifth confidence level (9.5×5=47.5). Thus, the user is awarded thirty-nine and a half points based on the relationships between the outcome values, the actual outcome values, and the selection positions of the respective selected potential outcomes. The user's unique fantasy score is calculated by adding the first and second values together (299.37+39.5=338.87).

A second signal indicative of the selected set value may be transmitted to the one or more user device 22. The second signal may also include an indication of a selected set status.

In one embodiment, the second signal is transmitted to the one or more user device 22 and indicates the user's unique score. The selected status may include indications of the user's unique score at any point in time throughout the game. The user's selected status may also include any other indications related to the user and the fantasy game 10, such as whether the user is winning or losing.

Because the selected set value is based at least in part on the relationship between the outcome values of the selected set and the actual outcome values of the selected set and at least in part on the relationship between the outcome values of the selected set, the actual outcome values of the selected set, and the selected positions of the selected set, the users are substantially more likely to each be afforded a distinct unique score, eliminating the issues of the prior art.

For example, if the round or season is set up so that each user is to select five potential outcomes, a portion of the users may select the same five potential outcomes. Still, a different part of the users may select at least one different potential outcome. Moreover, even those users who selected the same five potential outcomes may each receive a distinct unique score because the unique scores are also at least partially dependent on the selected positions of each of the selected set. It is further unlikely that each of the players who selected the exact selected set would assign them each the exact same selected positions. Thus, a substantial number of users may play in a round or season with a low probability of a substantial number of the users being awarded the same unique score in the end, avoiding ties and allowing for the users to be ranked individually from first to last.

To illustrate one example, refer back to Example 1 above. If a second user selected the same five potential outcomes but was to switch the confidence level one pick (Chiefs-Bills spread) with the confidence level five pick (Steph Curry over 23.5 points), the second user would be awarded 315.5 points (as opposed to the first user's 339.5 points) and would be ranked in a second position different from the first user's rank.

Additionally, indications of the user's selected set value and the user's selected set status increase user engagement and solve the issues of the prior art. Specifically, because the selected set value is based at least in part on the relationship between the outcome values of the selected set and the actual outcome values of the selected set and at least in part on the relationship between the outcome values of the selected set, the actual outcome values of the selected set, and the selected positions of the selected set, the selected set value is susceptible to rapid and/or unexpected change, thus causing the users to be more engaged. For example, in some embodiments where the selected set value is the unique score, the volatility of the unique score will cause the users to stay more engaged throughout the fantasy game 10—round or season.

The indications of the second signal transmitted to the one or more user device 22 may be displayed on display 24 and/or used for further processing, such as providing an award. However, it will be understood that the indications may include any form compatible with a sensory communication element of the one or more user device 22, such as sound through a speaker.

Generally, as with most fantasy sports games, the goal of the fantasy game 10 disclosed herein is to be awarded as many points as possible. The fantasy game 10 may be set up or conducted by the administrator, league manager, or one or more users. The fantasy game 10 may be set up in various ways, all well-known by those with skill in the art. For example, the fantasy game 10 may be set up so that the users have finite time frames to make a finite number of selections from the predetermined set of potential outcomes. Those potential outcomes may also be required to be determined within a predetermined time frame. For example, the one or more users may be required to select five bets for which the actual outcome of all five bets can be determined by the end of a given week.

Moreover, a variety of ways exist to conduct “rounds,” “seasons,” and/or “playoffs.” For example, a winner may be determined to be the user who has scored the most points over the course of one round against one or more other users or over the course of an entire season (compilation of rounds) against one or more other users. A winner may also be determined to be the user with the best record against one or more users over the course of a season. While many well-known ways exist to determine winners and losers of a fantasy sports game, the present disclosure is not limited to any one or more of them.

From the above description and examples, it is clear that the inventive concepts disclosed and claimed herein are well adapted to attain the advantages mentioned herein. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

What is claimed is:

1. A system comprising:
a processor;
a non-transitory computer readable memory storing computer executable instructions that, when executed by the processor, causes the processor to:
receive a predetermined set of potential outcomes, each potential outcome having an outcome type, an outcome selection, and an outcome value;
receive a first signal from one or more user device, the first signal indicative of a selected set of potential outcomes, each potential outcome in the selected set further having a selection position;
for one or more potential outcome of the selected set of potential outcomes, determine an actual outcome value for the outcome type and the outcome selection;
determine a selected set value for the selected set of potential outcomes based at least in part on the relationship between the outcome value and the actual outcome value and at least in part based on the relationship between the outcome value, the actual outcome value, and the selection position; and
transmit a second signal indicative of the selected set value and a selected set status to the one or more user device.

2. The system of claim 1, wherein the predetermined set of potential outcomes is supplied to the system by at least one user or administrator.

3. The system of claim 1, wherein the predetermined set of potential outcomes is supplied to the system by an outcome generator.

4. The system of claim 1, wherein the predetermined set of potential outcomes is a set of bets relating to at least one real-world sporting event.

5. The system of claim 1, wherein the actual outcome value is supplied to the system by at least one user or administrator.

6. The system of claim 1, wherein the actual outcome value is supplied to the system by an outcome generator.

7. The system of claim 1, wherein the second signal further causes the user device to display the selected set value.

8. A method of conducting a fantasy game, comprising:
receiving a predetermined set of potential outcomes, each potential outcome having an outcome type, an outcome selection, and an outcome value;
receiving a first signal from one or more user, the first signal indicative of a selected set of potential outcomes, each potential outcome in the selected set further having a selection position;
for one or more potential outcome of the selected set of potential outcomes, determining an actual outcome value for the outcome type and the outcome selection; and
determining a selected set value for the selected set of potential outcomes based at least in part on the relationship between the outcome value and the actual outcome value and at least in part based on the relationship between the outcome value, the actual outcome value, and the selection position.

9. The method of claim 8, wherein the predetermined set of potential outcomes is supplied to the system by at least one user or administrator.

10. The method of claim 8, wherein the predetermined set of potential outcomes is supplied to the system by an outcome generator.

11. The method of claim 8, wherein the predetermined set of potential outcomes is a set of bets relating to at least one real-world sporting event.

12. The method of claim 8, wherein the actual outcome value is supplied to the system by at least one user or administrator.

13. The method of claim 8, wherein the actual outcome value is supplied to the system by an outcome generator.

14. The method of claim 8, wherein the second signal further causes the user device to display the selected set value.
